(19) United States
(12) Patent Application Publication
(10) Pub. No.: US 2025/0010186 A1
(43) Pub. Date: Jan. 9, 2025

(54) REAL-TIME CONTEXTUAL INFORMATION DISPLAY METHOD, APPARATUS, STORAGE MEDIUM, AND ELECTRONIC DEVICE

(71) Applicant: Tencent Technology (Shenzhen) Company Limited, Shenzhen (CN)

(72) Inventors: Linying Xie, Shenzhen (CN); Jiaqi Pan, Shenzhen (CN); Zefeng Yang, Shenzhen (CN)

(21) Appl. No.: 18/891,322

(22) Filed: Sep. 20, 2024

Related U.S. Application Data
(63) Continuation of application No. PCT/CN2023/131152, filed on Nov. 13, 2023.

(30) Foreign Application Priority Data
Dec. 30, 2022 (CN) 2022117369535

(51) Int. Cl. A63F 13/52; A63F 13/533; A63F 13/58; A63F 13/67; A63F 13/837

(52) U.S. Cl. CPC A63F 13/52; A63F 13/533; A63F 13/58; A63F 13/67; A63F 13/837

(57) ABSTRACT

A real-time contextual information display method, apparatus, non-transitory storage medium, and electronic device is described herein. The method may include causing to be output a function interaction button during running of a virtual game task in which a first virtual object participates, controlling, based on a triggering of the function interaction button, the first virtual object to use a target function corresponding to a first-level state and a second-level state, determining and causing to be output level information of the target function and progress information of the target function, determining and causing to be output, based on a first use progress satisfying an upgrade condition corresponding to the first-level state, updated level information of the target function and updated progress information of the target function.

### CROSS-REFERENCE TO RELATED APPLICATIONS

This application is a continuation application of PCT Application PCT/CN2023/131152, filed Nov. 13, 2023, which claims priority to Chinese Patent Application No. 202211736953.5 filed on Dec. 30, 2022, each entitled “INFORMATION DISPLAY METHOD AND APPARATUS, STORAGE MEDIUM, AND ELECTRONIC DEVICE”, and each which is incorporated herein by reference in its entirety.

### FIELD

This application relates to the field of computers, and specifically, to a real-time contextual information display method, apparatus, storage medium, and electronic device.

### BACKGROUND

In an information display scene, in related art, a current state of a function is usually displayed, but relevant information is not provided on when or under what conditions the function can enter a next state. In related art, the information display method for the function is relatively monotonous, and a user cannot intuitively know a use progress of the function. In other words, there is a technical problem in related art that an information display method is relatively monotonous.

### SUMMARY

One or more aspects of this application provide an information display method, including:
causing to be output a function interaction button during running of a virtual game task in which a first virtual object participates;
controlling, based on a triggering of the function interaction button, the first virtual object to use a target function, the target function corresponding to at least two level states, and the at least two level states comprising a first-level state and a second-level state;
determining level information of the target function and progress information of the target function, the level information indicating that the target function is currently in the first-level state, and the progress information indicating a first use progress corresponding to the target function in the first-level state;
causing to be output the level information of the target function and the progress information of the target function;
determining, based on the first use progress satisfying an upgrade condition corresponding to the first-level state, updated level information of the target function and updated progress information of the target function, the updated level information indicating that the target function is in the second-level state, and the updated progress information indicating a second use progress corresponding to the target function in the second-level state; and
causing to be output the updated level information of the target function and the updated progress information of the target function

One or more aspects of this application further provide an information display apparatus, comprising one or more processors and memory storing computer-readable instructions that when executed by the one or more processors, cause the apparatus to:
cause to be output a function interaction button during running of a virtual game task in which a first virtual object participates;
control, based on a triggering of the function interaction button, the first virtual object to use a target function, the target function corresponding to at least two level states, and the at least two level states comprising a first-level state and a second-level state;
determine level information of the target function and progress information of the target function, the level information indicating that the target function is currently in the first-level state, and the progress information indicating a first use progress corresponding to the target function in the first-level state;
cause to be output the level information of the target function and the progress information of the target function;
determine, based on the first use progress satisfying an upgrade condition corresponding to the first-level state, updated level information of the target function and updated progress information of the target function, the updated level information indicating that the target function is in the second-level state, and the updated progress information indicating a second use progress corresponding to the target function in the second-level state; and
cause to be output the updated level information of the target function and the updated progress information of the target function

One or more aspects of this application provide a computer program product or a computer program, the computer program product or the computer program including computer instructions stored on a non-transitory computer-readable storage medium. One or more processors of a computer device reads the computer instructions from the non-transitory computer-readable storage medium, and executes the computer instructions to cause the computer device to perform the foregoing information display method.

One or more aspects of this application further provide an electronic device including a memory, a processor, and a computer program stored in the memory and capable of being run on the processor, the processor performing the foregoing information display method by using the computer program.

### BRIEF DESCRIPTION OF THE DRAWINGS

The accompanying drawings described herein are used to provide a further understanding of this application, and form a part of this application. In the accompanying drawings:

FIG. 1A is a schematic diagram of an implementation environment applicable to an information display method according to one or more aspects of this application.

FIG. 1B is a schematic diagram of an application environment of an information display method according to one or more aspects of this application.

FIG. 2 is a schematic flowchart illustrating one or more aspects of an information display method.

FIG. 3 is a schematic diagram illustrating one or more aspects of an information display method.

FIG. 4 is a schematic diagram illustrating one or more aspects of an information display method.

FIG. 5 is a schematic diagram illustrating one or more aspects of an information display method.

FIG. 6 is a schematic diagram illustrating one or more aspects of an information display method.

FIG. 7 is a schematic diagram illustrating one or more aspects of an information display method.

FIG. 8 is a schematic diagram illustrating one or more aspects of an information display method.

FIG. 9 is a schematic diagram illustrating one or more aspects of an information display method.

FIG. 10 is a schematic diagram illustrating one or more aspects of an information display method.

FIG. 11 is a schematic diagram illustrating one or more aspects of an information display method.

FIG. 12 is a schematic diagram illustrating one or more aspects of an information display method.

FIG. 13 is a schematic diagram illustrating one or more aspects of an information display method.

FIG. 14 is a schematic diagram illustrating one or more aspects of an information display method.

FIG. 15 is a schematic diagram illustrating one or more aspects of an information display method.

FIG. 16 is a schematic diagram illustrating one or more aspects of an information display apparatus.

FIG. 17 is a schematic diagram illustrating one or more aspects of a structure of an electronic device.

### DETAILED DESCRIPTION

To make a person skilled in the art better understand the solutions of this application, the following clearly and completely describes one or more aspects of the technical solutions of this application with reference to the accompanying drawings. Apparently, the described one or more aspects are not necessarily all of the one or more aspects of this application. All other aspects obtained by a person of ordinary skill in the art without creative efforts shall fall within the protection scope of this application.

In this specification, claims, and accompanying drawings of this application, the terms “first”, “second”, and the like are intended to distinguish similar objects but do not necessarily indicate a specific order or sequence. Such used terms are changeable under appropriate conditions, so that one or more aspects of this application described here can be implemented in an order other than those illustrated or described here. Moreover, the terms “include”, “have”, and any other variants are intended to cover the non-exclusive inclusion, for example, a process, method, system, product, or device that may include a list of operations or units is not necessarily limited to those expressly listed operations or units, but may include other operations or units not expressly listed or inherent to such a process, method, product, or device.

As described above, in an information display scene, especially in a specific shooting game scene, there is a function of an upgradeable skill. After a player reaches an upgrade condition through a specific game operation, the player is usually informed that an upgrade goal has been achieved only after upgrade is completed, and an upgrade display means is simply as a sentence or a mark to inform the player that the upgrade has been completed. However, during a game, the player does not know how many times a skill has been used, or how many times the user needs to use a skill before the skill can be upgraded. In other words, the player is not given a real-time prompt during the game, resulting in information display during the upgrade not being intuitive enough and the display means of a game upgrade progress of the player being relatively monotonous.

Therefore, one or more aspects of this application provide an information display method. According to the method, a problem that the information display is not intuitive enough when the game is upgraded can be resolved.

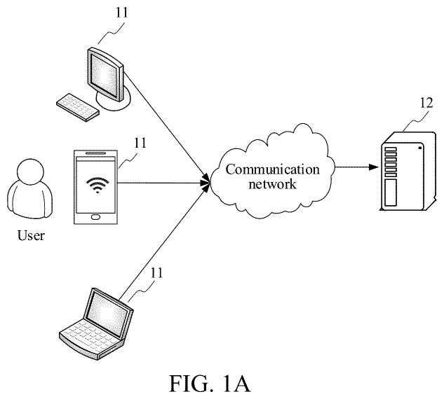

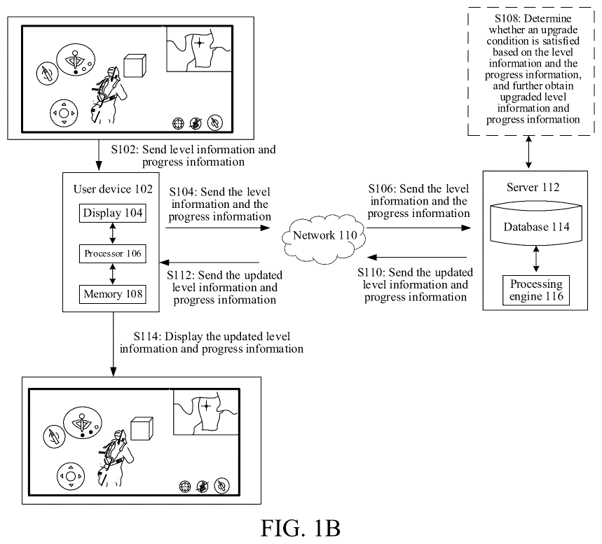

FIG. 1A is a schematic diagram of one or more aspects of an implementation environment. The implementation environment may include a user device 102 and a server 112. The user device 102 may communicate with the server 112 via a wired or wireless communication network.

The user may access the server 112 via a client installed in the user device 102. The client may be a game application client or may be installed in the user device 102. The server 112 may provide different services for the user, such as a game service.

In one or more aspects, the user device 102 may be an electronic device, such as a smartphone, a tablet, a laptop, a computer, a smart voice interaction device, a smart home appliance, a vehicle-mounted terminal, or an aircraft. The server 112 may be an independent physical server, a server cluster or distributed system including a plurality of physical servers, a cloud server providing a cloud service, a cloud database, cloud computing, a cloud function, cloud storage, a network service, cloud communication, a middleware service, a domain name service, a security service, a content delivery network (CDN), a big data and artificial intelligence platform, or the like, which is not limited herein.

Based on the implementation environment, an information display method is provided. As shown in FIG. 1B, the information display method may be performed by the user device 102 and/or the server 112 in the implementation environment shown in FIG. 1A. The user device 102 may include, but is not limited to, a display 104, a processor 106, and a memory 108. The server 112 may include a database 114 and a processing engine 116.

Specific processes are as following operations.

Operation S102: The user device 102 obtains level information and progress information triggered by a function interaction button.

Operation S104 to operation S106: Send the level information and the progress information to the server 112 via a network 110.

Operation S108: The server 112 determines whether an upgrade condition is satisfied based on the level information and the progress information by using the processing engine, and further obtains upgraded level information and progress information.

Operation S110 to operation S114: Send the updated level information and progress information to the user device 102 via the network 110, and the user device 102 displays the level information and the progress information on the display 108 by using the processor 106.

In addition to the example shown in FIG. 1, the foregoing operations may be implemented by a client or a server independently, or implemented by the client and the server coordinately. For example, the user device 102 may perform the foregoing operations such as S108, thereby reducing processing pressure of the server 112. The user device 102 may include but is not limited to a handheld device (such as a mobile phone), a laptop, a desktop computer, an on-board device, and the like. The specific implementations of the user device 102 are not limited in this application.

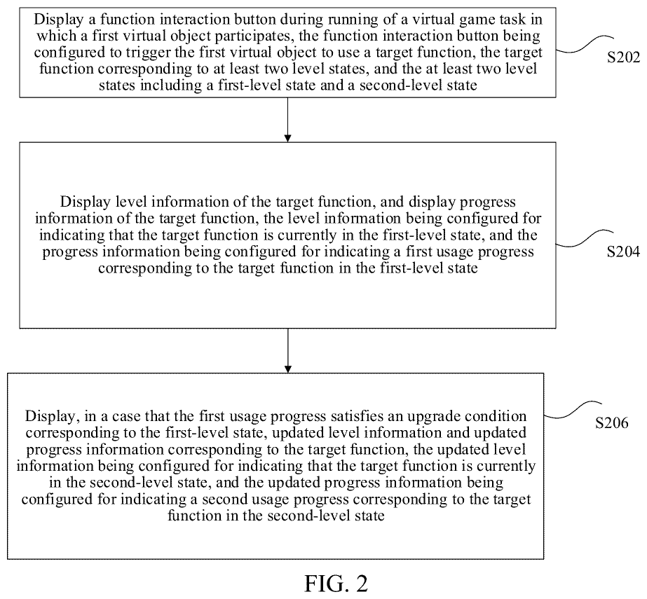

The following describes in detail the information display method one or more aspects with reference to the accompanying drawings. The method may be performed by a computer device. The computer device may be the foregoing user device. As shown in FIG. 2, the information display method may include the following operations.

S202: Display a function interaction button during running of a virtual game task in which a first virtual object participates, the function interaction button being configured to trigger the first virtual object to use a target function, the target function corresponding to at least two level states, and the at least two level states including a first-level state and a second-level state.

In one or more aspects, in response to a click/tap operation of the user on the function interaction button, the target function may be activated and the first virtual object may be triggered to use the target function.

S204: Display level information of the target function, and display progress information of the target function, the level information indicating that the target function is currently in the first-level state, and the progress information indicating a first use progress corresponding to the target function in the first-level state.

S206: Display updated level information and updated progress information of the target function based on a determination that the first use progress satisfies an upgrade condition corresponding to the first-level state, the updated level information indicating that the target function is currently in the second-level state, and the updated progress information indicating a second use progress corresponding to the target function in the second-level state.

In one or more aspects of this application, by using the function interaction button, the level information and level state may be fully displayed in real time when the player operates the game. When using the function interaction button, the player may be informed of a current skill use progress in a visual form of adding a segment in the function interaction button, to intuitively provide the user with a use progress in a current level state and progress information to a next level state. This improves diversity of a game display means and solves a problem that information display is not intuitive enough when the game is upgraded. This can avoid a problem of a cumbersome operation and low efficiency caused by a user's need to go to another page to view a skill level and an upgrade progress in the game during the game, to improve efficiency of human-computer interaction.

In one or more aspects of this application, the function interaction button may be understood as, but is not limited to, a button for casting a skill, changing a form, and/or the like during the game. The user may control the function interaction button through a touch screen, sound, and/or another manner to activate the above functions and/or enable the first virtual object to use the function. The function interaction button may activate a function that may be, but is not limited to, in an activated or inactivated state during a game task. The target function may be, but is not limited to, understood as two functions or functions corresponding to two different levels. For example, a first-level skill may be to provide a small field of view for bushes nearby, and the second-level skill may be to provide a field of view for an entire region nearby. In an example, the first-level skill may upgrade to the second-level skill after the player continuously hits a specific quantity of enemies. The target function may be to provide a field of view for an environment nearby, and different levels correspond to different function strengths.

In one or more aspects of this application, the target function may act on an individual user or on a group of users. For example, character A in an enemy faction may be hit continuously, and blood recovery speed of teammate B of character A may be reduced simultaneously. The target function may, but is not limited to, act on a target object, and may bring specific benefits to the user. For example, the first-level skill may provide the user with a specific field of view information or material information. Specifically, if player A is hit by a poisonous region within a period, player A may obtain information about whether there is bandage and/or another medicine within a specific range nearby. If player A is not attacked by the poisonous region for a long time, player A may know that player A has been upgraded to a second level through display of the function interaction button. The second-level skill may enable the player to know whether there is a first aid kit and another advanced medicine within a specific range nearby.

In one or more aspects of this application, the level information of the target function may be displayed in a first area of the function interaction button, and the progress information of the target function may be displayed in a second area of the function interaction button. The level information may indicate a current level of the target function. For example, the target function may be currently in the first-level state. The at least two level states may include the first-level state and the second-level state. The progress information may indicate the first use progress corresponding to the target function in first-level state.

In one or more aspects of this application, the level information of the target function displayed in the first area of the function interaction button may be understood, but is not limited to, as displaying a level information state of the target function. The level information state may include, but is not limited to, a plurality of level states. The plurality of level states may include, but are not limited to, indicating the current level information of the target function and displaying the progress information of the target function.

In one or more aspects of this application, the progress information of the target function may be determined based on a quantity of times a skill is casted and duration of the skill. A use progress of the target function may be determined based on the quantity of uses of the skill and the duration of the skill. For example, based on a determination that the quantity of uses exceeds a specific threshold, the progress information may be updated from a first-level progress to a second-level progress, and based on a determination that the duration exceeds a specific threshold, the progress information may be updated from the first-level progress to the second-level progress.

In one or more aspects of this application, when the first use progress satisfies the upgrade condition corresponding to the first-level state, the updated level information may be displayed in the first area, and the updated progress information may be displayed in the second area. The updated level information may indicate that the target function is currently in the second-level state, and the updated progress information may indicate a second use progress corresponding to the target function in the second-level state.

In one or more aspects of this application, the upgrade condition may include, but is not limited to, satisfying a specific preset threshold or reaching a specific activated level, which may be understood, but is not limited to, that the updated level information is displayed in the first area and the updated progress information is displayed in the second area. The first area and the second area may be displayed in different areas, or may be displayed in the same area in different forms simultaneously. In other words, the first area and the second area may be two different areas, or may partially overlap

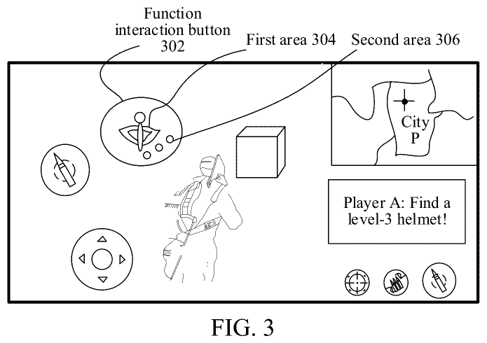

Further, for example, as shown in FIG. 3, when a player participates in a shooting game, a game character may have a shooting skill. In an initial state, the skill may be in a first-level state. Level information of the shooting skill displayed in a first area 304 in a function interaction button 302 may be the first-level state, and a first use progress of the shooting skill displayed in a second area 306 in the function interaction button 302 may be 0. During the game, when the game character uses an attack skill, each time the attack skill is used, the first use progress displayed in the second area 306 of the function interaction button 302 may be increased by one. Based on a determination that the first use progress satisfies an upgrade condition corresponding to the first-level state that is, when continuous attacks are reached, the first area 304 may be updated to level information corresponding to a second-level state, and the second area 306 may be updated to progress information corresponding to the second-level state.

In one or more aspects of this application, a function interaction button may be displayed during running of a virtual game task in which a first virtual object participates. The function interaction button may trigger the first virtual object to use a target function. The target function may be in any one of at least two level states. The at least two level states may include a first-level state and a second-level state. Level information of the target function may be displayed, and progress information of the target function may be displayed. The level information may indicate that the target function is currently in the first-level state, and the progress information may indicate a first use progress corresponding to the target function in the first-level state. Updated level information and updated progress information is configured for indicating displayed based on a determination that the first use progress satisfies an upgrade condition corresponding to the first-level state. The updated level information may indicate that the target function is currently in the second-level state, and the updated progress information may indicate a second use progress corresponding to the target function in the second-level state. A use progress in a current level state and progress information to a next level state is configured for indicating intuitively displayed in a manner of displaying the level information and the progress information in an area associated with the function interaction button, thereby further achieving an objective of intuitively displaying different function interaction information during the game, and achieving a technical effect of improving diversity of information display. In addition, this can avoid a problem of a cumbersome operation and low efficiency caused by a user's need to go to another page to view a skill level and an upgrade progress in the game during the game, to improve efficiency of human-computer interaction.

In one or more aspects of this application, the displaying progress information of the target function may include:
displaying a first quantity of first-level segments in a second area, the first quantity of first-level segments being configured to display a quantity of uses corresponding to the target function in the first-level state.

In one or more aspects of this application, a first target segment may display a quantity of uses of the target function corresponding to the first-level state. The quantity of uses of the target function may be specifically, but is not limited to, for example, once or twice. In one or more aspects, the quantity of uses of the target function may alternatively be an unspecified quantity of combos. For example, if an enemy is hit five times in a row, a quantity of uses of triggering may be combined into one. If an enemy is hit 10 times in a row, a quantity of uses of triggering may be combined into one two. The first-level segments may further display a quantity of uses when the target function of the first-level state satisfies the upgrade condition. Each time the target function of the first-level state is used, a segment may be filled. When all segments are filled, the upgrade condition of the first-level state may be satisfied.

According to one or more aspects provided in this application, the first quantity of first-level segments may be displayed in the second area. The first quantity of first-level segments may display the quantity of uses corresponding to the target function in the first-level state, thereby achieving an objective of using a quantity of segments to facilitate intuitive display, and achieving a technical effect of improving information display efficiency.

In one or more aspects of this application, the displaying a first-level quantity of first-level segments in a second area may include:

A first quantity of a first segment subsets and a second quantity of a second segment subsets may be displayed in the second area. A sum of the first quantity and the second quantity may be a first target quantity. The first segment subset may be a set including a first quantity of first-level segments in an empty state, and the second segment subset may be a set including a second quantity of first-level segments in a filled state. In other words, the first segment subset may include the first-level segments in the empty state. The second segment subset may include the first-level segments in the filled state. The first quantity of first segment subsets and the second quantity of second segment subsets may display a quantity of uses corresponding to the target function in the first-level state.

In one or more aspects of this application, the first-level quantity may display a quantity of first-level segments, including a quantity of segments in an empty state and a quantity of segments in a filled state. The first segment subset may be understood, but is not limited to, as a set of the first-level segments in the empty state. The first quantity may be understood, but is not limited to, as the quantity of first-level segments in the first segment subset that are in the empty state. The second segment subset may be understood, but is not limited to, as a set of the first-level segments in the filled state. The second quantity may be understood, but is not limited to, as a quantity of second-level segments in the second segment subset that are in the filled state.

According to one or more aspects provided in this application, the first segment subset including the first quantity of first-level segments and the second segment subset including the second quantity of first-level segments may be displayed in the second area. The sum of the first quantity and the second quantity may be the first-level quantity. The first segment subset may include the first-level segments in the empty state, and the second segment subset may include the first-level segments in the filled state. The first segment and the second segment may display the quantity of uses corresponding to the target function in the first-level state, thereby achieving a technical effect of improving display efficiency by using a quantity of filled and unfilled segments.

In one or more aspects, the displaying a first segment subset and a second segment subset in the second area may include:

displaying, in the second area, a first initial segment subset including a first initial quantity of first-level segments and a second initial segment subset including a second initial quantity of first-level segments, a sum of the first initial quantity and the second initial quantity being the first-level quantity; determining, in response to obtaining a use operation of the first virtual object on the target function in the first-level state, a preset quantity of segments from the first initial segment subset for filling to obtain a preset quantity of first-level segments in the filled state; adding the obtained preset quantity of first-level segments in the filled state to the second initial segment subset to obtain the second segment subset including the second quantity of first-level segments; and using a first initial segment subset form which the preset quantity of first-level segments are removed as the first segment subset including the first quantity of first-level segments, a difference between the first quantity and the first initial quantity being the preset quantity, and a difference between the second quantity and the second initial quantity being the preset quantity.

In this case, in combination with a quantity of target segments in a filled state and a quantity of target segments in an unfilled state, a technical effect of improving diversity of a display means is achieved.

In one or more aspects of this application, the first initial quantity may be understood, but is not limited to, before the use operation of the first virtual object that is triggered to use the target function in the first-level state is obtained, as the quantity of first-level segments in the first segment subset that are in the empty state. The second initial quantity may be understood, but is not limited to, before the use operation of the first virtual object that is triggered to use the target function in the first-level state is obtained, as the quantity of first-level segments in the second segment subset that are in the filled state. The first quantity may be understood, but is not limited to, after the use operation of the first virtual object that is triggered to use the target function in the first-level state is obtained, as the quantity of first-level segments in the first segment subset that are in the empty state The fourth initial quantity may be understood, but is not limited to, after the use operation of the first virtual object that is triggered to use the target function in the first-level state is obtained, as the quantity of first-level segments in the second segment subset that are in the filled state.

In one or more aspects, before the displaying updated level information and updated progress information corresponding to the target function, the method further may include:
determining, based on a determination that the first quantity is 0 or the second quantity is the first-level quantity, that the first use progress satisfies the upgrade condition corresponding to the first-level state.

According to one or more aspects provided in this application, based on a determination that the first quantity is 0 or the second quantity is the first-level quantity, it is determined that the first use progress satisfies the upgrade condition corresponding to the first-level state, thereby achieving an objective of filling a segment. Each time a segment quantity is filled, an objective of upgrading is achieved, to achieve a technical effect of improving information display efficiency.

In one or more aspects, after the determining that the first use progress satisfies the upgrade condition corresponding to the first-level state, the method further may include:
generating and displaying (or causing to be displayed) a dynamic special effect for indicating that the first-level state is upgraded to the second-level state; and
displaying, after the dynamic special effect playback ends, the updated level information in a first area, and displaying the updated progress information in the second area.

In one or more aspects of this application, the dynamic special effect for indicating that the first-level state is upgraded to the second-level state may include, but is not limited to, an aperture, a color, and/or the like, or may be, but is not limited to, a gradual change process, such as increasing display duration, or improving display efficiency. In addition, the updated level information and progress information may be respectively displayed in the first area and the second area after the dynamic special effect playback ends.

According to one or more aspects provided in this application, the dynamic special effect for indicating that the first-level state is upgraded to the second-level state may be generated and displayed. After the dynamic special effect display ends (e.g., playback of the dynamic special effect ends), the updated level information may be displayed in the first area and the updated progress information may be displayed in the second area, to significantly remind the user that the first-level state is upgraded to the second-level state, simplifying a user operation and improving human-computer interaction efficiency without a need of user's manual query of the current level.

In one or more aspects, the displaying updated level information and updated progress information corresponding to the target function may include:
displaying the updated level information in a first area, and displaying a second-level quantity of second-level segments in the second area, the second-level segments being configured to display a quantity of uses corresponding to the target function in the second-level state, and the second-level quantity being greater than or equal to the first-level quantity.

In one or more aspects, the displaying a function interaction button may include:
displaying the function interaction button based on a determination based on a determination that a distance between the first virtual object and a target object is less than a preset distance threshold. The target function used by the first virtual object may act on the target object.

In one or more aspects of this application, considering a balance of the game, after the first-level state is upgraded to the second-level state, level condition difficulty corresponding to the first-level state may be less than or equal to level condition difficulty corresponding to the second-level state, so that the player's balance of the game during the game is increased, the fun of the player is increased, and user experience is improved.

In one or more aspects, after the displaying a function interaction button, the method further may include:
controlling the first virtual object to use the target function in response to a trigger operation performed on the function interaction button; and
displaying reference information associated with the target object.

For example, in response to the first virtual object performing a click/tap operation on the function interaction button, a reconnaissance function may be activated to find out whether the second virtual object (a killer) is still alive and a location of the second virtual object.

In one or more aspects, the reference information associated with the target object may include reference information of the second virtual object and prompt information. The displaying reference information associated with the target object may include:
displaying the reference information of the second virtual object, the target object being an elimination mark generated after a third virtual object is eliminated, the second virtual object being a virtual object that eliminates the third virtual object and is not eliminated, and the first virtual object, the second virtual object, and the third virtual object jointly participating in the virtual game task; or
displaying the prompt information, the prompt information being configured for indicating that the second virtual object that eliminates the third virtual object is eliminated.

In one or more aspects, the displaying the reference information of the second virtual object may include:
displaying first reference information based on a determination that the target function is currently in the first-level state; or
displaying the first reference information and second reference information based on a determination that the target function is currently in the second-level state.

The first reference information may include location information of the second virtual object. The location information of the second virtual object may be, but is not limited to, current coordinates of the second virtual object in a mini-map, and/or a specific orientation or a building in which the second virtual object is located. The second reference information may include attribute information and configuration information of the second virtual object. The configuration information of the second virtual object may include, but is not limited to, a level of a virtual item, equipment, a rune, and/or the like currently owned by the second virtual object. The attribute information of the second virtual object may include, but is not limited to, an ID of the second virtual object, a winning rate of the second virtual object, armor information of the owned virtual item, basic health point information, and/or the like.

In one or more aspects, the displaying the reference information of the second virtual object may include at least one of the following:
displaying virtual identity information of the second virtual object;
displaying location information of the second virtual object;
displaying configuration information of the second virtual object;
displaying attribute information of the second virtual object; or
displaying team information of the second virtual object.

In one or more aspects of this application, the reference information of the second virtual object may be, but is not limited to, the virtual identity information of the second virtual object, such as the ID of the second virtual object, a quantity of people currently defeated by the second virtual object, and/or a title obtained by the second virtual object. For example, after the function is upgraded, the title of the second virtual object may be displayed as the “Kill leader” to indirectly inform a gaming level of the second virtual object and make better a decision.

In one or more aspects of this application, the location information of the second virtual object may be, but is not limited to, current coordinates of the second virtual object in a mini-map, and/or the specific orientation or the building in which the second virtual object is located. The configuration information of the second virtual object may include, but is not limited to, a level of a virtual item, equipment, a rune, and/or the like currently owned by the second virtual object. The attribute information of the second virtual object may include, but is not limited to, an ID of the second virtual object, a winning rate of the second virtual object, armor information of the owned virtual item, basic health point information, and/or the like, which is not redundantly limited here. The team information of the second virtual object may be understood, but is not limited to, as current team information of a killer, such as a quantity of surviving teams of the second virtual object and/or a team level of the second virtual object.

In one or more aspects of this application, after the displaying a function interaction button, the method further may include:
controlling the first virtual object to use the target function in response to a trigger operation performed on the function interaction button;
setting a state of the target function to a cooldown state, and hiding the function interaction button; and
setting, based on a determination that duration of the target function being in the cooldown state is greater than or equal to a preset duration threshold, the state of the target function to an activated state, and displaying the function interaction button.

In one or more aspects, after the displaying updated level information and updated progress information corresponding to the target function, the method further may include:
displaying, based on a determination that the second use progress satisfies an upgrade condition corresponding to the second-level state and a third-level state is a higher-level state among the at least two level states, additional updated level information updated in the first area, and hiding progress information in the second area, the additional updated level information indicating that the target function is currently in the third-level state.

Further, the foregoing technical features may be displayed in a specific scene.

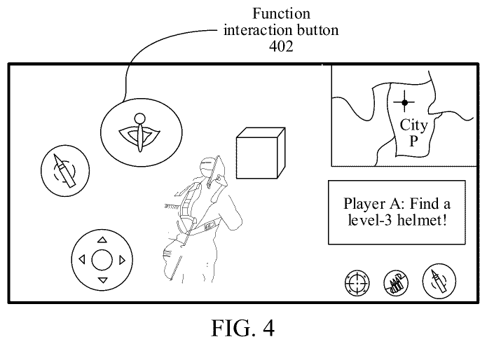

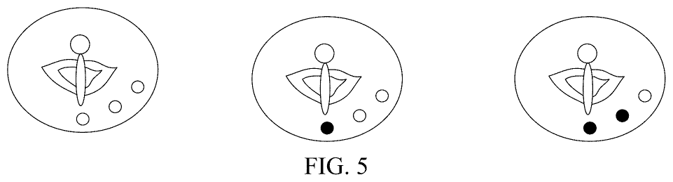

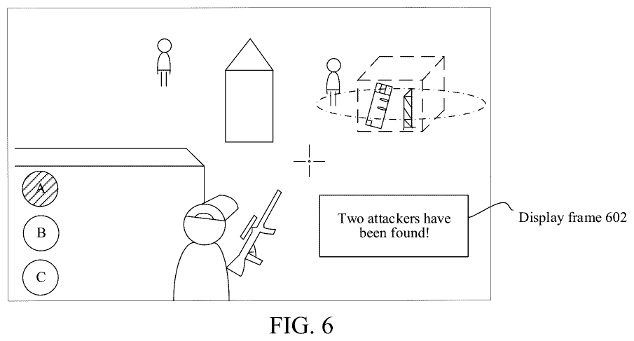

In a shooting game, when a player dies, a virtual item (such as, a death chest of a dead player) including all items of the player may be left. Currently, a hero has a skill to check a location of a killer by using a virtual item. If the killer is still alive, the location and a skill of the killer may be directly displayed. If the killer is not alive, the location and the skill of the killer might not be displayed. In an initial state (that is, at the beginning of each game, when a skill level of the player is level 1), when the player using the hero gets close to a virtual item of another team player (for example, the death chest left by the another team player after the another team player is dead), a skill icon and a skill interaction button 402 may appear on a model. As shown in FIG. 4, a skill upgrade condition may be using the skill 3 times, and then the skill is upgraded to level 2. In the initial state, there may be three points in the lower right corner of the skill interaction button 402, which may be used to count a quantity of uses, as specifically shown in FIG. 5. As shown in FIG. 6, when the player presses the skill interaction button when aiming at the virtual item, a check function may be triggered, and a location of a currently alive player (a quantity of the alive players ranges from 0 to 3) who kills the dead player may be displayed in a display frame 602 at the top of an interface. In addition, the skill button for the same virtual item may enter cooldown and may disappear after a use state ends. To prevent the player from frequently refreshing a location of an enemy, rechecking might not be allowed within a specific period (for example, 10 seconds).

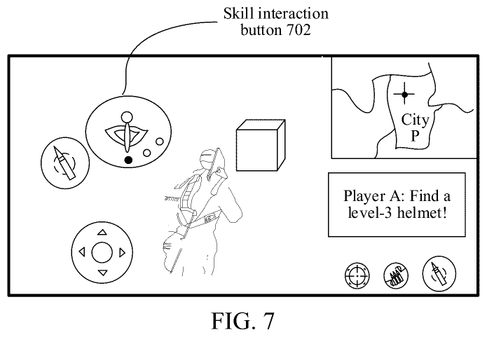

For example, as shown in FIG. 7, when the player discovers another virtual item or cooldown of the same virtual item ends, a skill interaction button 702 may appear again, and a quantity of counting points in the lower right corner of a skill icon may be refreshed to indicate that one point bas been accumulated.

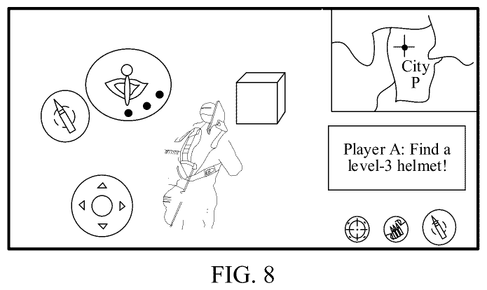

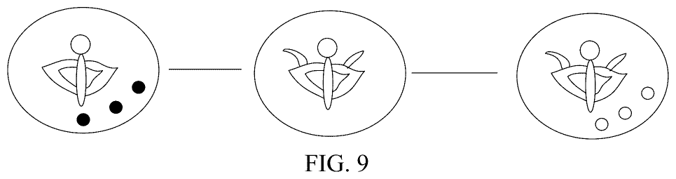

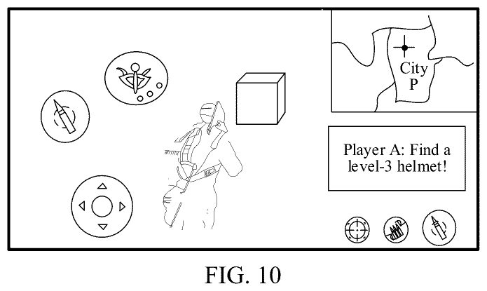

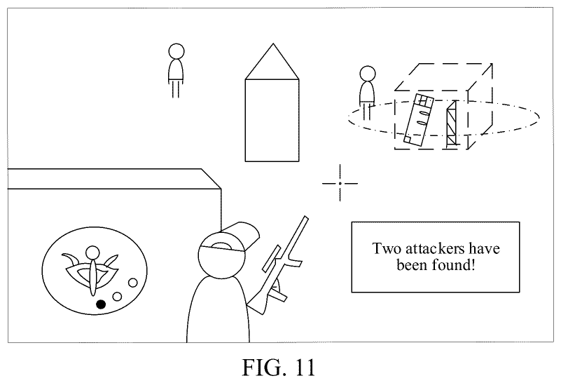

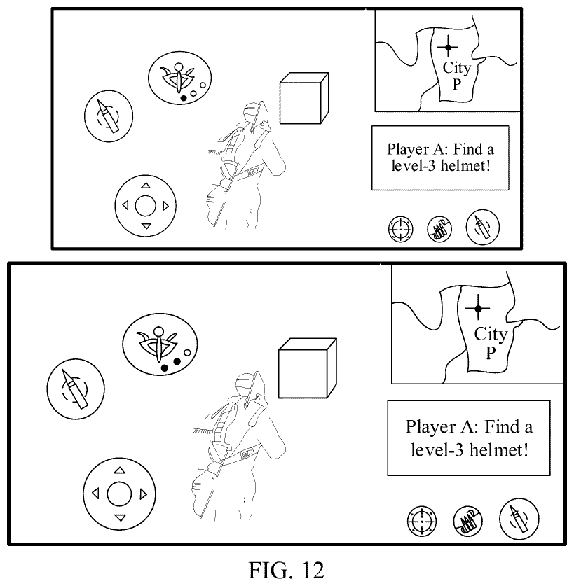

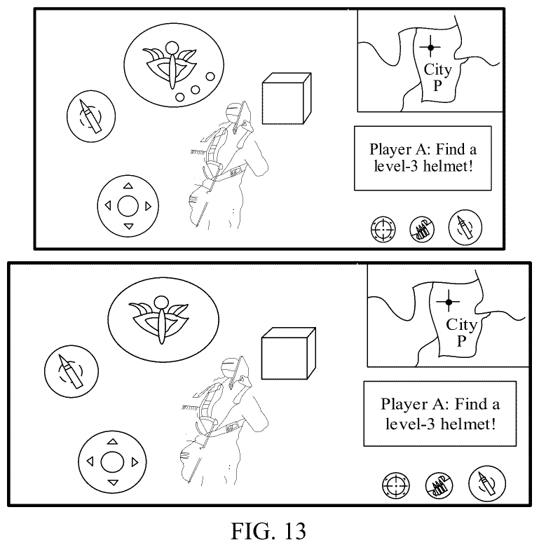

For example, as shown in FIG. 8, when the player uses a skill a quantity of times (that is, three times) required for upgrading, points may be fully accumulated. During a period in which the button does not disappear in the use state, an animation effect of accumulating points and upgrading to a next level may be played on the skill button. A specific special effect process is shown in FIG. 9. When a condition of using a skill is triggered next time, the skill icon has already been an icon of the next level, as shown in FIG. 10. As shown in FIG. 11, when the skill level is 2, after the player uses a check skill, a count increases, and a hero avatar and armor information of an attacker (zero to three attackers) may be additionally displayed by the skill effect. At the next time, a quantity of uses is increased by one, as shown in FIG. 12. After the skill is used six times, the skill may be upgraded to level 3, and the counting points may disappear and not be displayed again. In this case, the skill may already be in a final state, as shown in FIG. 13.

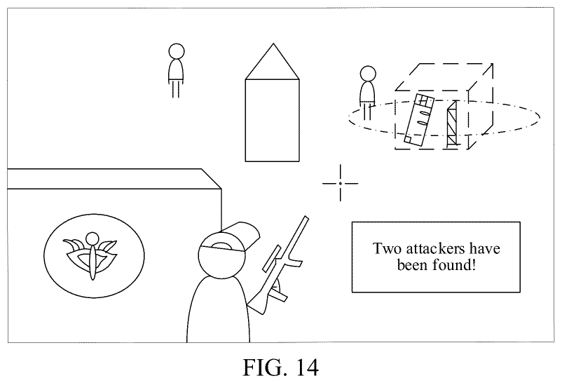

For example, in the final state of the skill in FIG. 14, a skill interaction icon may be shown as the final level state. An effect after the player uses the skill is the same as that of level 2, but may be refreshed in real time every five seconds. When the player uses the hero in a battle, coordinates (x, y) of the player are recorded. Within a diameter range of the coordinates (x, y), if there is a virtual item, it may be detected whether the virtual item belongs to a teammate. If the virtual item does not belong to a teammate, a skill interaction button may appear. The skill interaction button may include two parts: a skill icon (distinguishing between levels 1, 2, and 3) and counting points (1 to 3 points, distinguishing between an unused state and a used state). When a screen detects that the player clicks/taps the skill interaction button, a killer record of a dead player and a name of the killer may be obtained from a server, and a name of an entire killer team may be obtained based on a team name record. After a killer team ID is obtained, it may be detected whether the killer is dead. If the killer is not dead, coordinates (xn, yn) of all killers from the server may be obtained, the killer may be marked with a red enemy mark on a map, and an entire team of the player may be informed of a location of a remaining player in the killer team. If the killer is dead, the following message (or something similar) may at the top: No surviving killer. After a skill process is completed, the skill may be first displayed in an in-use state, then may begin cooldown, and a skill count may be increased by 1. A resource corresponding to a counting point in an icon may be displayed in the used state, to provide the player with current count information. After the player uses the skill three times, the counting points may be fully accumulated, the skill may be upgraded to level 2, and the skill button icon may be replaced with a level-2 skill icon. When the player uses a level-2 skill, a hero name and armor data of a currently remaining killer may be additionally requested from the server and may be reflected in the virtual item of the player using the skill. After the player uses the skill six times, the skill may be upgraded to level 3, and the skill button icon may be replaced with a level-3 skill icon. When the player uses a level-3 skill, all effects of levels 1 and 2 may be included, and a location of a remaining enemy killer may be refreshed in real time every five seconds.

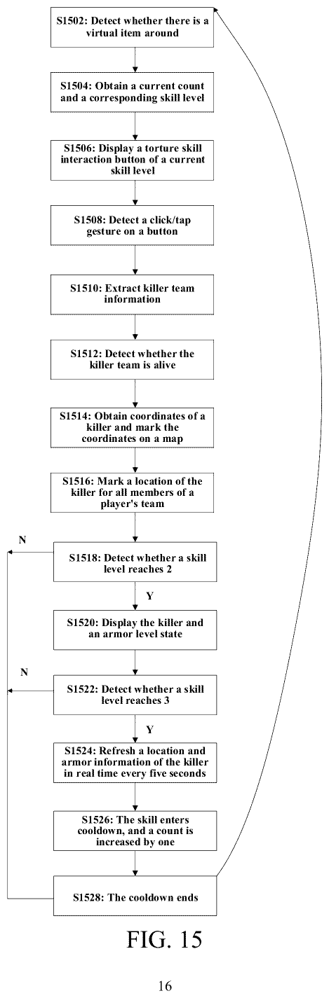

For example, as shown in FIG. 15, operation S1502: Detect whether there is a virtual item around, specifically, record coordinates (x, y) of a player; detect, within a diameter range of (x, y), if there is a virtual item, whether the virtual item belongs to a teammate; and perform operation S1504 if the virtual item does not belong to the teammate.

Operation S1504: Obtain a current count and a corresponding skill level, specifically, record coordinates (x, y) of a player; detect, within the diameter range of the coordinate (x, y), if there is the virtual item, whether the virtual item belongs to the teammate; and perform operation S1506 if the virtual item does not belong to the teammate.

Operation S1506: Display a torture skill interaction button of a current skill level, specifically, display a skill interaction button. The skill interaction button may include two parts: a skill icon (distinguishing between levels a twenty 1, 2, and 3) and counting points (1 to 3 points (also referred to as segments), distinguishing between an unused state and a used state).

Operation S1508: Detect a click/tap gesture on a button, specifically, activate a skill corresponding to the skill interaction button when a screen detects the click/tap gesture on the button.

Operation S1510: Extract killer team information, specifically, obtain a killer record of a dead player and a name of the killer from a server, and obtain a name of an entire killer team based on a team name record.

Operation S1512: Detect whether the killer team is alive, specifically, query, after the killer team name is obtained, the server whether a killer is dead.

Operation S1514: Obtain coordinates of the killer and mark the coordinates on a map, specifically, obtain, after a result fed back by the server is obtained, coordinates (xn, yn) of all killers from the server if the killer is not dead. If the killer is dead, the following message or a similar message appears at the top: No surviving killer.

Operation S1516: Mark a location of the killer for all members of a player's team, specifically, mark the killer with a red enemy marks on a map, and inform the entire team of the player of a location of a remaining player in the killer team.

Operation S1518: Detect whether a level reaches 2, specifically, feed yes back if the level reaches 2; or feed no back if the level does not reach 2.

Operation S1520: Display a legend and an armor level state of the killer. Specifically, after the player uses the skill three times, the counting points may be fully accumulated, in other words, all the counting points are filled, the skill may be upgraded to level 2, and the skill button icon may be replaced with a level-2 skill icon; and when the player uses a level-2 skill, a hero name and armor data of a currently remaining killer may be additionally requested from the server and displayed in the interface of the player using the skill.

Operation S1522: Detect whether a skill level reaches 3, specifically, feed yes back if the level reaches 3; or feed no back if the level does not reach 3.

Operation S1524: Refresh a location and armor information of the killer in real time every five seconds. Specifically, after the player uses the skill six times, the skill may be upgraded to level 3, and the skill button icon may be replaced with a level-3 skill icon; and when the player uses a level-3 skill, all effects of levels 1 and 2 may be included, and a location of a remaining enemy killer may be refreshed in real time every five seconds.

Operation S1526: The skill begins cooldown, a count is increased by one, which are reflected on the icon. Specifically, before the skill level reaches 3, each time the player uses the skill, the counting point in the skill icon may change from the unused state to the used state, to prompt the player of a current count progress (a quantity of uses of a function); and after the skill is used, the skill may begin cooldown and a state of the skill may change, and when there is a virtual item around, the skill interaction button might not be displayed again.

Operation S1528: The cooldown ends, specifically, normally display the skill interaction button when the cooldown ends and a condition (that is, there is the virtual item around) is satisfied.

In one example, relevant data such as user information may be used. Based on a determination that the foregoing one or aspects of this application may be applied to a specific product or technology, a permission or consent of a user is required, and collection, use, and processing of the relevant data need to comply with relevant laws, regulations, and standards of relevant countries and regions.

For each of the foregoing method aspects, for ease of description, the method aspects are described as a series of action combinations. But a person of ordinary skill in the art is to know that this application is not limited to any described sequence of the action, as some operations can use other sequences or can be executed simultaneously according to this application. In addition, a person skilled in the art also knows that one or more aspects described in the specification are examples, and the related actions and modules are not necessarily required by this application.

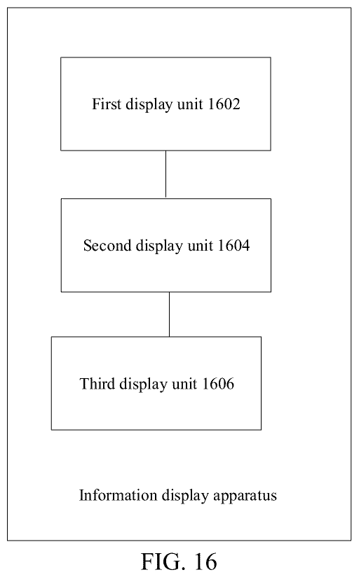

An information display apparatus for implementing the information display method is further provided. As shown in FIG. 16, the apparatus may include:
a first display unit 1602, configured to display a function interaction button during running of a virtual game task in which a first virtual object participates, the function interaction button triggering the first virtual object to use a target function, the target function corresponding to at least two level states, and the at least two level states including a first-level state and a second-level state;
a second display unit 1604, displaying level information of the target function, and displaying progress information of the target function, the level information indicating that the target function is currently in the first-level state, and the progress information indicating a first use progress corresponding to the target function in the first-level state; and
a third display unit 1606, displaying, based on a determination that the first use progress satisfies an upgrade condition corresponding to the first-level state, updated level information and updated progress information corresponding to the target function, the updated level information indicating that the target function is currently in the second-level state, and the updated progress information indicating a second use progress corresponding to the target function in the second-level state.

In one or more aspects, the second display unit may include:
a first display module, configured to display a first-level quantity of first-level segments in a second area of the function interaction button, the first-level quantity of first-level segments displaying a quantity of uses corresponding to the target function in the first-level state.

In one or more aspects, the first display module may include:
a first display submodule, configured to display a first segment subset and a second segment subset in the second area, the first segment subset being a set including a first quantity of first-level segments in an empty state, the second segment subset being a set including a second quantity of first-level segments in a filled state, a sum of the first quantity and the second quantity being the first-level quantity, and the first segment subset and the second segment subset displaying the quantity of uses corresponding to the target function in the first-level state.

In one or more aspects, the first display submodule may include:
a first display subunit, configured to display, in the second area, a first initial segment subset including a first initial quantity of first-level segments and a second initial segment subset including a second initial quantity of first-level segments, a sum of the first initial quantity and the second initial quantity being the first-level quantity;
a first determining subunit, configured to determine, in response to obtaining a use operation of the first virtual object on the target function in the first-level state, a preset quantity of segments from the first initial segment subset for filling to obtain a preset quantity of first-level segments in the filled state;
a second display subunit, configured to add the obtained preset quantity of first-level segments in the filled state to the second initial segment subset to obtain the second segment subset including the second quantity of first-level segments; and use a first initial segment subset form which the preset quantity of first-level segments are removed as the first segment subset including the first quantity of first-level segments, a difference between the first quantity and the first initial quantity being the preset quantity, and a difference between the second quantity and the second initial quantity being the preset quantity.

In one or more aspects, the apparatus further may include:
a first determining module, configured to determine, before the updated level information is displayed in the first area, and the updated progress information is displayed in the second area, as well as based on a determination that the first quantity is 0 or the second quantity is the first-level quantity, that the first use progress satisfies the upgrade condition corresponding to the first-level state.

In one or more aspects, the apparatus further may include:
a first playing module, configured to play, after it is determined that the first use progress satisfies the upgrade condition corresponding to the first-level state, a dynamic special effect for indicating that the first-level state is upgraded to the second-level state; and
a second display module, configured to display, after the dynamic special effect playback ends, the updated level information in a first area, and display the updated progress information in the second area.

In one or more aspects, the first display module may include:
a second display submodule, configured to display the updated level information in a first area, and display a second-level quantity of second-level segments in the second area, the second-level segments displaying a quantity of uses corresponding to the target function in the second-level state, and the second-level quantity being greater than or equal to the first-level quantity.

In one or more aspects, the first display unit may include:
a third display module, configured to display the function interaction button based on a determination that a distance between the first virtual object and a target object is less than a preset distance threshold. The target function used by the virtual object may act on the target object.

In one or more aspects, the apparatus further may include:
a first control module, configured to control, after the function interaction button is displayed, the first virtual object to use the target function in response to a trigger operation performed on the function interaction button; and
a second control module, configured to display reference information associated with the target object after the function interaction button is displayed.

In one or more aspects, the reference information associated with the target object may include reference information of the second virtual object and prompt information. The second control module may include:
a third display submodule, configured to display the reference information of the second virtual object, the target object being an elimination mark generated after a third virtual object is eliminated, the second virtual object being a virtual object that eliminates the third virtual object and is not eliminated, and the first virtual object, the second virtual object, and the third virtual object jointly participating in the virtual game task; or
a fourth display submodule, configured to display the prompt information, the prompt information indicating that the second virtual object that eliminates the third virtual object is eliminated.

In one or more aspects, the third display submodule may include:
a third display subunit, configured to display first reference information based on a determination that the target function is currently in first-level state; or
a fourth display subunit, configured to display the first reference information and second reference information based on a determination that the target function is currently in the second-level state.

In one or more aspects, the third display submodule may include a display subunit configured to display at least one of the following:
virtual identity information of the second virtual object;
location information of the second virtual object;
configuration information of the second virtual object;
attribute information of the second virtual object; or
team information of the second virtual object.

In one or more aspects, the apparatus may include:
a third control module, configured to control, after the function interaction button is displayed, the first virtual object to use the target function in response to a trigger operation performed on the function interaction button;
a first hiding module, configured to set, after the function interaction button is displayed, a state of the target function to a cooldown state, and hide the function interaction button; and
a first setting module, configured to set, after the function interaction button is displayed and based on a determination that duration of the target function being in the cooldown state is greater than or equal to a preset duration threshold, the state of the target function to an activated state, and display the function interaction button.

In one or more aspects, the apparatus further may include:
a fourth display module, configured to display, after the updated level information is displayed in the first area, and the updated progress information is displayed in the second area, as well as based on a determination that the second use progress satisfies an upgrade condition corresponding to the second-level state and a third-level state is a higher-level state among the at least two level states, level information updated again in the first area, and hide progress information in the second area, the level information updated again being configured for indicating that the target function is currently in the third-level state.

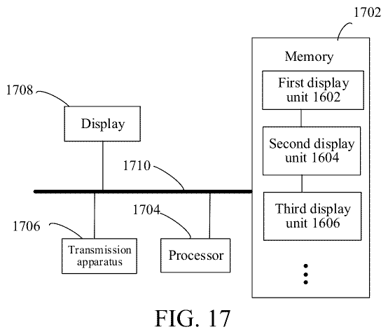

According to another aspect of this application, an electronic device configured to implement the foregoing information display method is further provided. As shown in FIG. 17, the electronic device may include a memory 1702 and a processor 1704. The memory 1702 may have a computer program stored therein, and the processor 1704 may be configured to perform operations in the foregoing method by using the computer program.

In one or more aspects, the electronic device may be located in at least one of a plurality of network devices in a computer network.

In one or more aspects, the processor may be configured to execute the computer program to perform the following operations.
S1: Display a function interaction button during running of a virtual game task in which a first virtual object participates, the function interaction button being configured to trigger the first virtual object to use a target function, the target function corresponding to at least two level states, and the at least two level states including a first-level state and a second-level state;
S2: Display level information of the target function, and display progress information of the target function, the level information indicating that the target function is currently in the first-level state, and the progress information indicating a first use progress corresponding to the target function in the first-level state; and
S3: Display, based on a determination that the first use progress satisfies an upgrade condition corresponding to the first-level state, updated level information and updated progress information corresponding to the target function, the updated level information indicating that the target function is currently in the second-level state, and the updated progress information indicating a second use progress corresponding to the target function in the second-level state.

In one or more aspects, a person of ordinary skill in the art may understand that, the structure shown in FIG. 17 is only for example. The electronic device may be a terminal device, such as a smartphone (such as an Android mobile phone, or an iOS mobile phone), a tablet computer, a palmtop computer, a mobile Internet device (MID), or a PAD. The structure of the foregoing electronic device is not limited in FIG. 17. For example, the electronic device may further include more or fewer components (for example, a network interface) than those shown in FIG. 17, or may have a configuration different from that shown in FIG. 17.

The memory 1702 may be configured to store a software program and a module, such as a program instruction/module corresponding to the information display method and apparatus, and the processor 1704 may perform various functional applications and data processing by running the software program and the module stored in the memory 1702, in other words, implements the foregoing information display method. The memory 1702 may include a high-speed random memory, and may further include a non-volatile memory, such as one or more magnetic storage apparatuses, a flash memory, or another non-volatile solid-state memory. In one or more aspects, the memory 1702 may further include memories remotely disposed relative to the processor 1704, and the remote memories may be connected to a terminal over a network. Examples of the network include, but are not limited to, the Internet, an intranet, a local area network, a mobile communication network, and a combination thereof. The memory 1702 may be specifically configured, but is not limited to, to store information such as a candidate detection point set, a blocking degree, and a target detection point set. As an example, as shown in FIG. 17, the memory 1702 may include, but is not limited to, the first display unit 1602, the second display unit 1604, and the third display unit 1606 in the foregoing information display apparatus. In addition, another module unit in the foregoing information display apparatus may be included, but is not limited, which is not repeated in the example.

A transmission apparatus 1706 may be configured to receive or transmit data via a network. Specific examples of the network include a wired network and a wireless network. In an example, the transmission apparatus 1706 may include a network interface controller (NIC). The network interface controller may be connected to another network device and a router via a network cable, to communicate with the Internet or a local area network. In an example, the transmission apparatus 1706 may be a radio frequency (RF) module. The radio frequency module may communicate with the Internet in a wireless manner.

In addition, the electronic device further may include: a display 1708, configured to display information such as the candidate detection point set, the blocking degree, and the target detection point set; and a connection bus 1710, configured to connect each module component in the electronic device.

In one example, the foregoing terminal device or server may be a node in a distributed system. The distributed system may be a blockchain system, the blockchain system may be a distributed system formed by connecting a plurality of nodes through network communication. A peer to peer (P2P) network may be formed between the nodes. Any form of a computing device, such as the server, the terminal, and another electronic device, may become a node in the blockchain system by joining the peer-to-peer network.

According to an aspect in this application, a computer program product is provided. The computer program product may include a computer program/instructions. The computer program/instructions include program code used for performing the method shown in the accompanying drawings. The computer program may be downloaded and installed from a network through the communication part, and/or installed from the removable medium. When executed by a central processing unit, the computer program executes functions provided in the foregoing method.

The sequence numbers of the one or more aspects of this application are merely for description, and do not imply the preference among the one or more aspects.

The computer system of the electronic device is merely an example, and does not constitute any limitation on functions and use ranges in one or more aspects of this application.

The computer system may include a central processing unit (CPU), which may perform various suitable actions and processing according to a program stored in a read-only memory (ROM) or a program loaded from a storage part into a random access memory (RAM). In the random access memory, various programs and data required by system operations are further stored. The central processing unit, the read-only memory, and the random access memory are connected to each other through a bus. An input/output (I/O) interface is also connected to the bus.

The following components may be connected to the input/output interface: an input part including a keyboard, a mouse, or the like; an output part including a cathode ray tube (CRT), a liquid crystal display (LCD), a speaker, or the like; a storage part including a hard disk, or the like; and a communication part including a network interface card such as a local area network (LAN) card or a modem. The communication part performs communication processing over a network such as the Internet. A driver may be also connected to the input/output interface as required. A removable medium, such as a magnetic disk, an optical disc, a magneto-optical disk, or a semiconductor memory, may be installed on the driver as required, so that a computer program read from the removable medium may be installed into the storage part as required.

The processes described in the accompanying drawings may be implemented as a computer software program. For example, one or more aspects of this application may include a computer program product, the computer program product may include a computer program carried on a computer-readable medium, and the computer program may include program code used for performing the foregoing method. The computer program may be downloaded and installed from a network through the communication part, and/or installed from the removable medium. When the computer program is executed by the central processing unit, the various functions defined in the system of this application may be executed.

According to an aspect of this application, a non-transitory computer-readable storage medium is provided. A processor of a computer device reads computer instructions from the non-transitory computer-readable storage medium. The processor may execute the computer instructions, to enable the computer device to perform the foregoing method.

In one or more aspects of this application, the non-transitory computer-readable storage medium may be configured to store a computer program configured for performing the following operations:
S1: Display a function interaction button during running of a virtual game task in which a first virtual object participates, the function interaction button being configured to trigger the first virtual object to use a target function, the target function corresponding to at least two level states, and the at least two level states including a first-level state and a second-level state;
S2: Display level information of the target function, and display progress information of the target function, the level information indicating that the target function is currently in the first-level state, and the progress information indicating a first use progress corresponding to the target function in the first-level state; and
S3: Display, based on a determination that the first use progress satisfies an upgrade condition corresponding to the first-level state, updated level information and updated progress information corresponding to the target function, the updated level information indicating that the target function is currently in the second-level state, and the updated progress information indicating a second use progress corresponding to the target function in the second-level state.

In one or more aspects of this application, a person of ordinary skill in the art may understand that all or some operations in the foregoing methods may be performed by a program instructing relevant hardware of the terminal device. The program may be stored in a computer-readable storage medium. The storage medium may include: a flash drive, a read-only memory (ROM), a random access memory (RAM), a magnetic disk, an optical disc, and the like.

When the integrated unit is implemented in the form of a software functional unit and sold or used as an independent product, the integrated unit may be stored in the foregoing computer-readable storage medium. Based on such an understanding, the technical solutions of this application essentially, or the part contributing to the related art, or all or some of the technical solutions may be implemented in a form of a software product. The computer software product may be stored in a storage medium and may include a plurality of instructions for instructing one or more computer devices (which may be a personal computer, a server, a network device, or the like) to perform all or some of the operations of the methods described herein.

In one example, the disclosed client may be implemented in another manner. The apparatus described above is merely an example. For example, the division of the units is merely the division of logic functions, and there may be other division manners in other implementations. For example, a plurality of units or components may be combined, or may be integrated into another system, or some features may be omitted or not performed. In addition, the displayed or discussed couplings or direct couplings, or communication connections may be implemented by using some interfaces. The indirect couplings or communication connections between the units or modules may be implemented in electric or other forms.

The units described as separate parts may or might not be physically separate, and components displayed as units may or might not be physical units, that is, may be located in one place, or may be distributed on a plurality of network units. Some or all of the units may be selected based on actual needs to implement the objectives described herein.

In addition, functional units of this application may be integrated into one processing unit, or each of the units may be physically separated, or two or more units may be integrated into one unit. The integrated unit may be implemented in the form of hardware, or may be implemented in a form of a software functional unit.

The foregoing descriptions are not limiting, and a person of ordinary skill in the art may make various improvements and refinements without departing from the principle of this application. All such modifications and refinements should also be intended to be covered by this application.

What is claimed is:

1. A computer-assisted method, comprising:
causing to be output a function interaction button during running of a virtual game task in which a first virtual object participates;
controlling, based on a triggering of the function interaction button, the first virtual object to use a target function, the target function corresponding to at least two level states, and the at least two level states comprising a first-level state and a second-level state;
determining level information of the target function and progress information of the target function, the level information indicating that the target function is currently in the first-level state, and the progress information indicating a first use progress corresponding to the target function in the first-level state;
causing to be output the level information of the target function and the progress information of the target function;
determining, based on the first use progress satisfying an upgrade condition corresponding to the first-level state, updated level information of the target function and updated progress information of the target function, the updated level information indicating that the target function is in the second-level state, and the updated progress information indicating a second use progress corresponding to the target function in the second-level state; and
causing to be output the updated level information of the target function and the updated progress information of the target function.

2. The method according to claim 1, wherein the causing to be output progress information of the target function comprises:
causing to be output a first-level quantity of first-level segments in a first area of the function interaction button, the first-level quantity of first-level segments displaying a quantity of uses corresponding to the target function in the first-level state.

3. The method according to claim 2, wherein the causing to be output a first-level quantity of first-level segments in a first area of the function interaction button comprises:
causing to be output a first segment subset and a second segment subset in the first area, the first segment subset comprising a first quantity of first-level segments in an empty state, wherein the second segment subset comprises a second quantity of first-level segments in a filled state, wherein a sum of the first quantity and the second quantity is the first-level quantity, and wherein the first segment subset and the second segment subset displaying the quantity of uses corresponding to the target function in the first-level state.

4. The method according to claim 3, wherein the causing to be output a first segment subset and a second segment subset in the first area comprises:
causing to be output, in the first area, a first initial segment subset comprising a first initial quantity of first-level segments and a second initial segment subset comprising a second initial quantity of first-level segments, a sum of the first initial quantity and the second initial quantity being the first-level quantity;
determining, in response to obtaining a use operation of the first virtual object on the target function in the first-level state, a preset quantity of segments from the first initial segment subset for filling to obtain a preset quantity of first-level segments in the filled state;
adding the obtained preset quantity of first-level segments in the filled state to the second initial segment subset to obtain the second segment subset comprising the second quantity of first-level segments; and
using a first initial segment subset for which the preset quantity of first-level segments are removed as the first segment subset comprising the first quantity of first-level segments,
wherein a difference between the first quantity and the first initial quantity is the preset quantity, and
wherein a difference between the second quantity and the second initial quantity is the preset quantity.

5. The method according to claim 3, wherein before the causing to be output the updated level information of the target function and the updated progress information of the target function, the method further comprises:
determining, based on a determination that the first quantity is 0 or the second quantity is the first-level quantity, that the first use progress satisfies the upgrade condition corresponding to the first-level state.

6. The method according to claim 5, wherein after the determining that the first use progress satisfies the upgrade condition corresponding to the first-level state, the method further comprises:
causing to be output a dynamic special effect for indicating that the first-level state is upgraded to the second-level state; and
causing to be output, after playback of the dynamic special effect is complete, the updated level information in a second area, and causing to be output the updated progress information in the first area.

7. The method according to claim 2, wherein the causing to be output the updated level information of the target function and the updated progress information of the target function comprises:
causing to be output the updated level information in a second area, and causing to be output a second-level quantity of second-level segments in the first area, the second-level segments displaying a quantity of uses corresponding to the target function in the second-level state, and the second-level quantity being greater than or equal to the first-level quantity.

8. The method according to claim 1, wherein the causing to be output a function interaction button comprises:
causing to be output the function interaction button based on a determination that a distance between the first virtual object and a target object is less than a preset distance threshold.

9. The method according to claim 8, wherein after the controlling the target object, the method further comprises:
causing to be output reference information associated with the target object.

10. The method according to claim 9, wherein:
the reference information associated with the target object comprises reference information of a second virtual object and prompt information, and
the causing to be output reference information associated with the target object comprises: causing to be output the reference information of the second virtual object, the target object being an elimination mark generated after a third virtual object is eliminated, the second virtual object being a virtual object that eliminates the third virtual object, and the first virtual object, the second virtual object, and the third virtual object jointly participating in the virtual game task; or
causing to be output the prompt information, the prompt information indicating that the second virtual object that eliminates the third virtual object is eliminated.

11. The method according to claim 10, wherein the causing to be output the reference information of the second virtual object comprises:
causing to be output first reference information based on a determination that the target function is currently in the first-level state; or
causing to be output the first reference information and second reference information based on a determination that the target function is currently in the second-level state.

12. The method according to claim 10, wherein the causing to be output the reference information of the second virtual object comprises at least one of the following:
causing to be output virtual identity information of the second virtual object;
causing to be output location information of the second virtual object;
causing to be output configuration information of the second virtual object;
causing to be output attribute information of the second virtual object; or
causing to be output team information of the second virtual object.

13. The method according to claim 1, wherein after the causing to be output a function interaction button, the method further comprises:
setting a state of the target function to a cooldown state;
hiding the function interaction button;
setting, based on a determination that duration of the target function being in the cooldown state is greater than or equal to a preset duration threshold, the state of the target function to an activated state;
causing to be output the function interaction button.

14. The method according to claim 6, wherein after the causing to be output updated level information and updated progress information corresponding to the target function, the method further comprises:
causing to be output, based on a determination that the second use progress satisfies an upgrade condition corresponding to the second-level state and a third-level state is a higher-level state among the at least two level states, additional updated level information updated in the second area, and hiding progress information in the first area, the additional updated level information indicating that the target function is currently in the third-level state.

15. An apparatus comprising:
one or more processors; and
memory storing computer-readable instructions that when executed by the one or more processors, cause the apparatus to:
cause to be output a function interaction button during running of a virtual game task in which a first virtual object participates;
control, based on a triggering of the function interaction button, the first virtual object to use a target function, the target function corresponding to at least two level states, and the at least two level states comprising a first-level state and a second-level state;
determine level information of the target function and progress information of the target function, the level information indicating that the target function is currently in the first-level state, and the progress information indicating a first use progress corresponding to the target function in the first-level state;
cause to be output the level information of the target function and the progress information of the target function;
determine, based on the first use progress satisfying an upgrade condition corresponding to the first-level state, updated level information of the target function and updated progress information of the target function, the updated level information indicating that the target function is in the second-level state, and the updated progress information indicating a second use progress corresponding to the target function in the second-level state; and
cause to be output the updated level information of the target function and the updated progress information of the target function.

16. The apparatus according to claim 15, wherein the causing to be output progress information of the target function comprises:
causing to be output a first-level quantity of first-level segments in a first area of the function interaction button, the first-level quantity of first-level segments displaying a quantity of uses corresponding to the target function in the first-level state.

17. The apparatus according to claim 16, wherein the causing to be output a first-level quantity of first-level segments in a first area of the function interaction button comprises:
causing to be output a first segment subset and a second segment subset in the first area, the first segment subset comprising a first quantity of first-level segments in an empty state, wherein the second segment subset comprises a second quantity of first-level segments in a filled state, wherein a sum of the first quantity and the second quantity is the first-level quantity, and wherein the first segment subset and the second segment subset displaying the quantity of uses corresponding to the target function in the first-level state.

18. A non-transitory computer readable media storing instructions that when executed by one or more processors, cause the one or more processors to:
cause to be output a function interaction button during running of a virtual game task in which a first virtual object participates;
control, based on a triggering of the function interaction button, the first virtual object to use a target function, the target function corresponding to at least two level states, and the at least two level states comprising a first-level state and a second-level state;
determine level information of the target function and progress information of the target function, the level information indicating that the target function is currently in the first-level state, and the progress information indicating a first use progress corresponding to the target function in the first-level state;
cause to be output the level information of the target function and the progress information of the target function;
determine, based on the first use progress satisfying an upgrade condition corresponding to the first-level state, updated level information of the target function and updated progress information of the target function, the updated level information indicating that the target function is in the second-level state, and the updated progress information indicating a second use progress corresponding to the target function in the second-level state; and
cause to be output the updated level information of the target function and the updated progress information of the target function.

19. The non-transitory computer readable media according to claim 18, wherein the causing to be output progress information of the target function comprises:
causing to be output a first-level quantity of first-level segments in a first area of the function interaction button, the first-level quantity of first-level segments displaying a quantity of uses corresponding to the target function in the first-level state.

20. The non-transitory computer readable media according to claim 19, wherein the causing to be output a first-level quantity of first-level segments in a first area of the function interaction button comprises:
causing to be output a first segment subset and a second segment subset in the first area, the first segment subset comprising a first quantity of first-level segments in an empty state, wherein the second segment subset comprises a second quantity of first-level segments in a filled state, wherein a sum of the first quantity and the second quantity is the first-level quantity, and wherein the first segment subset and the second segment subset displaying the quantity of uses corresponding to the target function in the first-level state.
